(19) United States
(12) Patent Application Publication
(10) Pub. No.: US 2010/0042667 A1
(43) Pub. Date: Feb. 18, 2010

(54) System and method for transmitting illusory identification characteristics

(75) Inventors: Alexander A. Cohen, Mill Valley, CA (US); Edward K.Y. Jung, Bellevue, WA (US); Royce A. Levien, Lexington, MA (US); Robert W. Lord, Seattle, WA (US); Mark A. Malamud, Seattle, WA (US); William H. Mangione-Smith, Kirkland, WA (US); John D. Rinaldo, JR., Bellevue, WA (US); Clarence T. Tegreene, Bellevue, WA (US)

Correspondence Address: LEE & HAYES, PLLC, 601 W RIVERSIDE, SUITE 1400, SPOKANE, WA, 99201, US

(73) Assignee: Searete LLC, a limited liability corporation of the State of Delaware

(21) Appl. No.: 12/228,664

(22) Filed: Aug. 14, 2008

(51) Int. Cl. G06F 15/16

(52) U.S. Cl. 709/201

(57) ABSTRACT

Methods and systems for transmitting illusory identification characteristics are provided.

A method for transmitting illusory identification characteristics may comprise: (a) receiving one or more requests from a first user to associate one or more illusory user identification characteristics with the first user; and (b) transmitting one or more illusory identification characteristics associated with the first user to a second user.

A system for transmitting illusory identification characteristics may comprise: (a) means for receiving one or more requests from a first user to associate one or more illusory user identification characteristics with the first user; and (b) means for transmitting one or more illusory identification characteristics associated with the first user to a second user.

### BACKGROUND

Electronic communications between one or more participants are ubiquitous in today's world. One or more participants in a communication via electronic devices may desire to maintain a level of secrecy with respect to one or more of their identification characteristics during such communications. As such, illusory identification characteristics may be utilized by one or more participants engaging in electronic communications.

### BRIEF DESCRIPTION OF THE FIGURES

FIG. 1 shows a high-level block diagram of a system for providing illusory identification characteristics.

FIG. 2 is a high-level logic flowchart of a process.

FIG. 3 is a high-level logic flowchart of a process.

FIG. 4 is a high-level logic flowchart of a process.

FIG. 5 is a high-level logic flowchart of a process.

FIG. 6 is a high-level logic flowchart of a process.

FIG. 7 is a high-level logic flowchart of a process.

FIG. 8 is a high-level logic flowchart of a process.

FIG. 9 is a high-level logic flowchart of a process.

FIG. 10 is a high-level logic flowchart of a process.

FIG. 11 is a high-level logic flowchart of a process.

FIG. 12 is a high-level logic flowchart of a process.

FIG. 13 is a high-level logic flowchart of a process.

FIG. 14 is a high-level logic flowchart of a process.

FIG. 15 is a high-level logic flowchart of a process.

FIG. 16 is a high-level logic flowchart of a process.

FIG. 17 shows a high-level block diagram of a computer program product.

FIG. 18 shows a high-level block diagram of a system for providing illusory identification characteristics.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

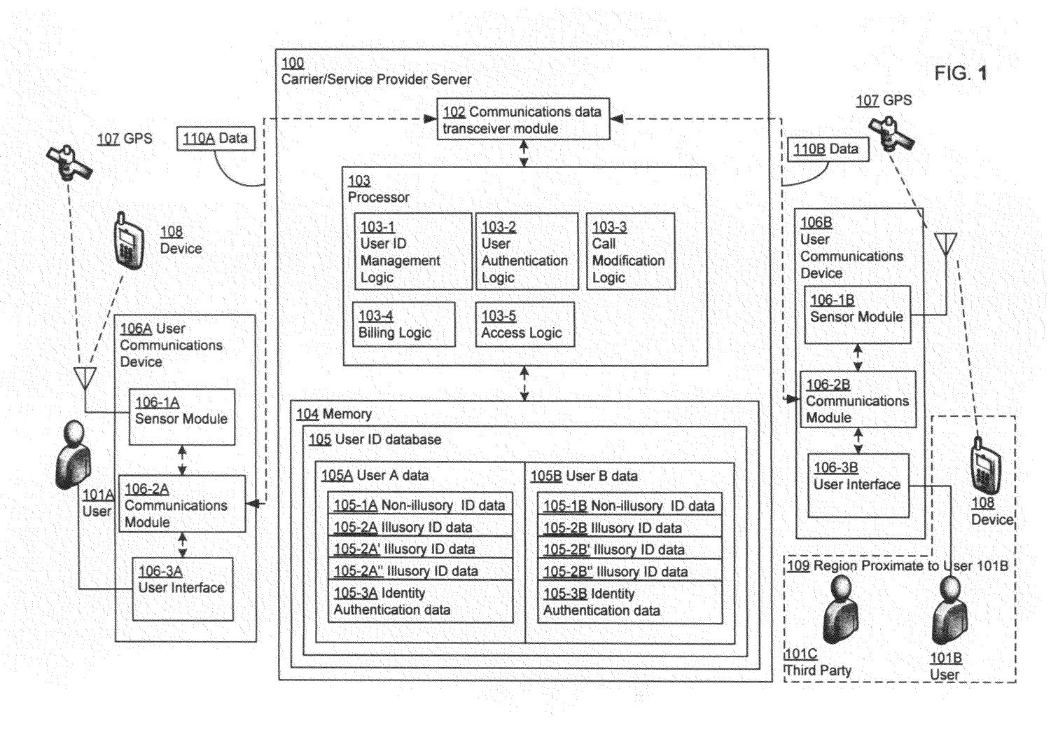

FIG. 1 illustrates an example environment in which one or more technologies may be implemented. A system for providing illusory identification characteristics may include a carrier/service provider server 100 a user communications device 106A associated with a first user 101A and a user communications device 106B associated with a second user 101B (e.g. subscription communications services for first user 101A and second user 101B that are activated on user communications device 106A and user communications device 106B respectively).

Although the first user 101A and second user 101B may be shown/described herein as a single illustrated figure, those skilled in the art will appreciate that the first user 101A and second user 101B may be representative of a human user, a robotic user (e.g., computational entity), and/or substantially any combination thereof (e.g., a user may be assisted by one or more robotic agents). The first user 101A and/or the second user 101B may include, but are not limited to, a voicemail service, a text messaging service, a web-based application service, and the like.

The carrier/service provider server 100 may be an integrated or distributed server system associated with one or more communications networks. Numerous communications networks may be used. Examples of communications networks may include, but are not limited to, a voice over internet protocol (VoIP) network (e.g. networks maintained by Vonage®, Verizon®, Sprint®), a cellular network (e.g. networks maintained by Verizon®, Sprint®, AT&T®, T-Mobile®), a text messaging network (e.g. an SMS system in GSM), and an e-mail system (e.g. an IMAP, POP3, SMTP, and/or HTTP e-mail server) and the like.

The carrier/service provider server 100 may include a communications data transceiver module 102. Numerous types of data transceiver modules may be used. Examples of data transceiver modules may include, but are not limited to, a cellular transceiver, a satellite transceiver and a network portal (e.g. a modem linked to an internet service provider).

The carrier/service provider server 100 may include a processor 103. Numerous types of processors may be used (e.g. general purpose processors such those marketed by Intel® and AMD, application specific integrated circuits, and the like). For example, the processor 103 may include one or more logic blocks capable of performing one or more computational functions, such as user-ID management logic 103-1, user-authentication logic 103-2, call modification logic 103-3, billing logic 103-4 and/or system access logic 103-5.

The carrier/service provider server 100 may include memory 104. Numerous types of memory may be used (e.g. RAM, ROM, flash memory, and the like). The memory 104 may include a user-ID database 105 including user-ID data for one or more users (e.g. user A data 105A associated with the first user 101A and user B data 105B associated with the second user 101B). A user-ID database item for a user may include one or more fields including user identity data. For example, the user A data 105A may include non-illusory ID data 105-1A, one or more illusory ID data (e.g. illusory ID data 105-2A, 105-2A′, 105-2A″, etc.), and/or user ID authentication data 105-3A. The user B data 105B may include non-illusory ID data 105-1B, one or more illusory ID data (e.g. illusory ID data 105-2B, 105-2B′, 105-2B″, etc.), and/or user ID authentication data 105-3B.

The user A data 105A and/or the user B data 105B may include data representing various identification characteristics of one or more users (e.g. first user 101A and/or second user 101B). The identification characteristics of the one or more users may include, but are not limited to, user names, identification numbers, telephone numbers and/or associated supplemental codes (e.g. area codes and the like), images, voice prints, locations, ages, sex, gender, physical trait, and the like. Such identification characteristics may be illusory (e.g. the identification characteristic includes one or more fictitious elements with respect to attributes of first user 101A or second user 101B) or non-illusory (e.g. the identification characteristic accurately reflects attributes of the first user 101A or second user 101B).

The first user 101A and the second user 101B may communicate using user communications device 106A and user communications device 106B, respectively. Numerous communications devices may be used. For example, the user communications device 106A and user communications device 106B may include, but are not limited to, a cell phone, satellite phone, Blackberry®, landline phone, a VoIP enabled device and/or computing device (e.g. a desktop or laptop computer). The user communications device 106A and user communications device 106B may include a sensor module 106-1A and/or a sensor module 106-1B, respectively. Numerous sensor modules may be used. For example, the sensor module 106-1A and/or sensor module 106-1B may include, but are not limited to, one or more of an image capture device (e.g. a digital camera), a microphone, a global positioning system (GPS) receiver, an electromagnetic radiation receiver, a biometric sensor, a retinal scanner and a fingerprint scanner.

The user communications device 106A and user communications device 106B may include a communications modules 106-2 (e.g. communications modules 106-2A and communications modules 106-2B respectively). Numerous communications modules may be used. For example, the communications modules 106-2A and/or the communications modules 106-2B may include, but are not limited to, one or more of a cellular transceiver, a Bluetooth transceiver, a WiFi transceiver, a satellite transceiver and a network port (e.g. a modem).

The user communications device 106A and user communications device 106B may include a user interface 106-3A and a user interface 106-3B, respectively. Numerous user interfaces may be used. For example, the user interface 106-3A and/or the user interface 106-3B may include, but is not limited to, one or more of a display screen, a touchscreen, a keypad, a speaker system and a microphone.

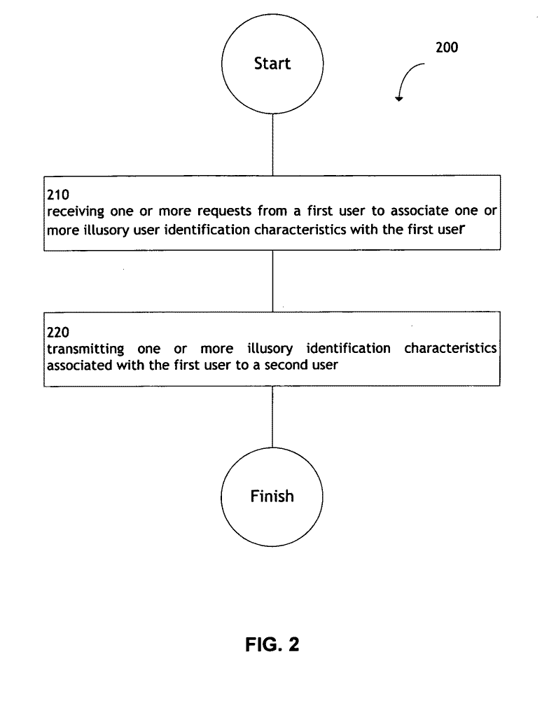

FIG. 2 illustrates an operational flow 200 representing example operations related to transmitting illusory identification characteristics. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those that are illustrated, or may be performed concurrently.

After a start operation, the operational flow 200 moves to an operation 210. Operation 210 depicts receiving one or more requests from a first user to associate one or more illusory user identification characteristics with the first user. For example, as shown in FIG. 1, the communications data transceiver module 102 of the carrier/service provider server 100 may receive a request by a first user 101A made from a user communications device 106A to associate one or more illusory user identification characteristics (e.g. a characteristic which does not correspond to a user's actual characteristic) with the first user 101A. The first user 101A may provide an input through a user interface 106-3A of user communications device 106A whereby the first user 101A requests that the carrier/service provider server 100 associate an illusory identification characteristic represented by illusory ID data 105-2A be associated with first user 101A. The communications modules 106-2A of the user communications device 106A may transmit data 110A representing the request which may be received by the communications data transceiver module 102 of the carrier/service provider server 100. The user-ID management logic 103-1 of the processor 103 may cause the memory 104 to store data 110A representing one or more illusory user identification characteristics to a portion of user-ID database 105 associated with a user (e.g. illusory ID data 105-2A) in order to associate the illusory user identification characteristic with the user.

Then, operation 220 depicts transmitting one or more illusory identification characteristics associated with the first user to a second user. For example, as shown in FIG. 1, the communications data transceiver module 102 of the carrier/service provider server 100 may transmit data 110B including illusory ID data 105-2A associated with first user 101A to a user communications device 106B associated with second user 101B. The illusory ID data 105-2A may be received by a communications modules 106-2B of the user communications device 106B and presented to the second user 101B via the user interface 106-3B of the user communications device 106B. The communications data transceiver module 102 may transmit data 110B in any number of communications data formats including, but not limited to a voice call (e.g. a landline or wireless phone call), a text message, an e-mail or a VoIP call.

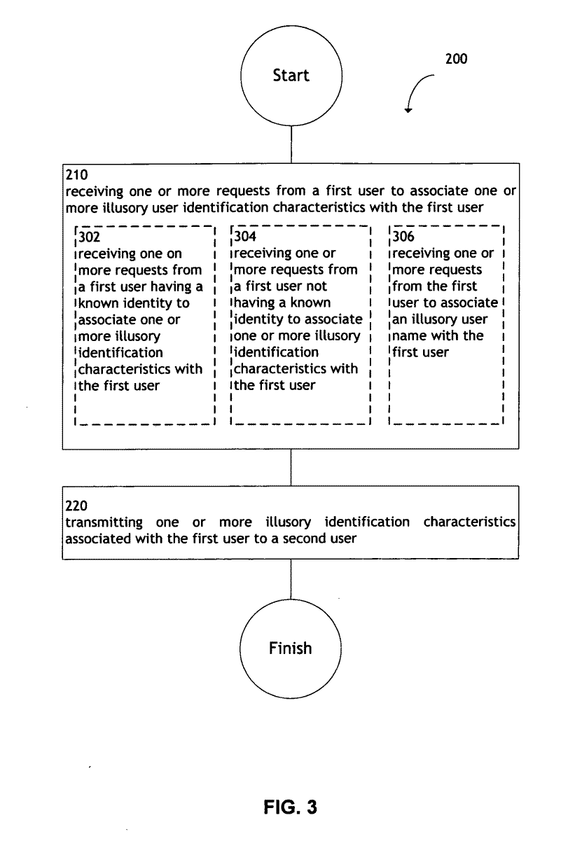

FIG. 3 illustrates alternative embodiments of the example operational flow 200 of FIG. 2. FIG. 3 illustrates example embodiments where the operation 210 may include at least one additional operation. Additional operations may include an operation 302, an operation 304, and/or an operation 306.

The operation 302 illustrates receiving one or more requests from a first user having a known identity to associate one or more illusory identification characteristics with the first user. For example, as shown in FIG. 1, the carrier/service provider server 100 may receive a request to associate one or more illusory identification characteristics from a first user 101A having an existing user-ID database 105 file (e.g. user A data 105A). Alternately, the carrier/service provider server 100 may receive a request to associate one or more illusory identification characteristics from a first user 101A via a user communications device 106A recognized by the carrier/service provider server 100 as belonging to a database of devices associated with known users.

The operation 304 illustrates receiving one or more requests from a first user not having a known identity to associate one or more illusory identification characteristics with the first user. For example, as shown in FIG. 1, the carrier/service provider server 100 may receive a request to associate one or more illusory identification characteristics from a first user 101A lacking an existing user-ID database 105 file. Alternately, the carrier/service provider server 100 may receive a request to associate one or more illusory identification characteristics from a first user 101A via a user communications device 106A which is not recognized by the carrier/service provider server 100 as belonging to a database of devices associated with a known first user 101A. Such an unrecognized first user 101A may request carrier/service provider server 100 services on a single or limited-use basis (e.g. through use of a services calling-card) where illusory identification characteristics associated with the unrecognized first user 101A identity may not be maintained in the user-ID database 105.

The operation 306 illustrates receiving one or more requests from the first user to associate an illusory user name with the first user. For example, as shown in FIG. 1, the carrier/service provider server 100 may receive a request from first user 101A to associate an illusory user name maintained as illusory ID data 105-2 associated with first user 101A. The associated illusory user name may be provided as part of data 110B transmitted to second user 101B by the carrier/service provider server 100 so as to disguise the user name of first user 101A.

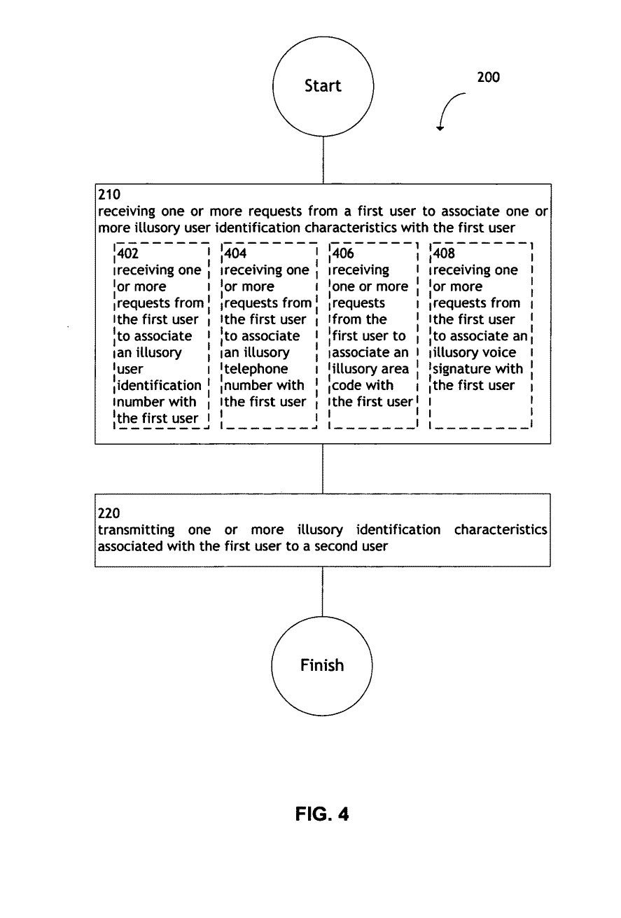

FIG. 4 illustrates alternative embodiments of the example operational flow 200 of FIG. 2. FIG. 4 illustrates example embodiments where the operation 210 may include at least one additional operation. Additional operations may include an operation 402, an operation 404, an operation 406, and/or an operation 408.

The operation 402 illustrates receiving one or more requests from the first user to associate an illusory user identification number with the first user. For example, as shown in FIG. 1, the carrier/service provider server 100 may receive a request from first user 101A to associate an illusory user identification number (e.g. a social security number) maintained as illusory ID data 105-2A associated with first user 101A. The associated illusory user identification number may be provided as part of data 110B transmitted to second user 101B by the carrier/service provider server 100 so as to disguise the user identification number of first user 101A.

The operation 404 illustrates receiving one or more requests from the first user to associate an illusory telephone number with the first user. For example, as shown in FIG. 1, the carrier/service provider server 100 may receive a request from first user 101A to associate an illusory user telephone number maintained as illusory ID data 105-2A associated with first user 101A. The associated illusory user telephone number may be provided as part of data 110B transmitted to second user 101B by the carrier/service provider server 100 so as to disguise the user telephone number of first user 101A.

The operation 406 illustrates receiving one or more requests from the first user to associate an illusory area code with the first user. For example, as shown in FIG. 1, the carrier/service provider server 100 may receive a request from first user 101A to associate an illusory user area code (e.g. an international dialing code; country codes, city codes, cell phone codes, NANPA codes, ITU-T code, a code established under the North American Numbering Plan, and the like) maintained as illusory ID data 105-2A associated with first user 101A. The associated illusory user area code may be provided as part of data 110B transmitted to second user 101B second user 101B by the carrier/service provider server 100 so as to disguise the area code of first user 101A.

The operation 408 illustrates receiving one or more requests from the first user to associate an illusory voice signature with the first user. For example, as shown in FIG. 1, the carrier/service provider server 100 may receive a request from first user 101A to associate an illusory user voice signature (e.g. a voice signature having an altered pitch, tone, volume relative to the actual voice signature of first user 101A) maintained as illusory ID data 105-2A associated with first user 101A. The associated illusory user area code may be provided as part of data 110B transmitted to second user 101B by the carrier/service provider server 100 so as to disguise the voice signature of first user 101A.

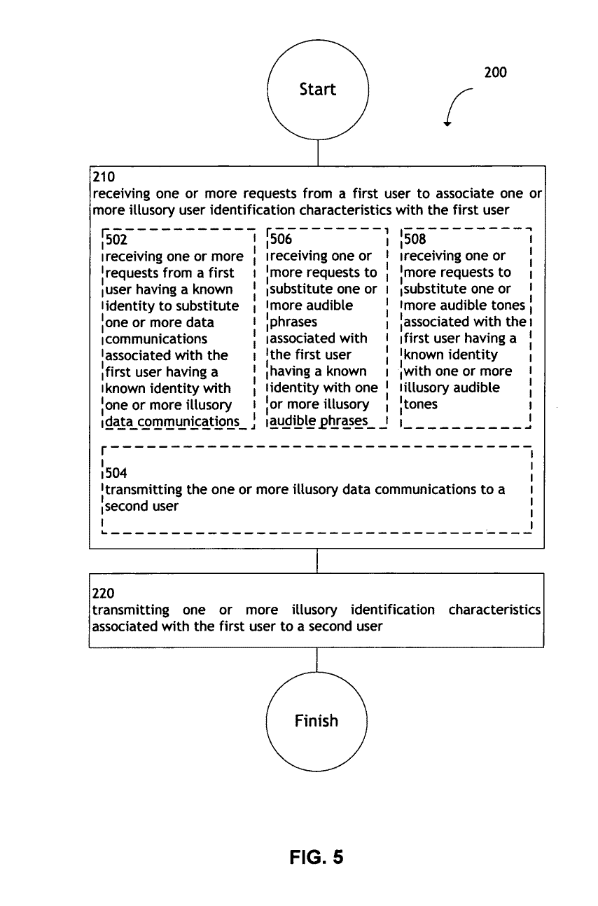

FIG. 5 illustrates alternative embodiments of the example operational flow 200 of FIG. 2. FIG. 5 illustrates example embodiments where the operation 210 may include at least one additional operation. Additional operations may include an operation 502, an operation 504, an operation 506, and/or an operation 508.

The operation 502 illustrates receiving one or more requests from a first user having a known identity to substitute one or more communications data associated with the first user having a known identity with one or more illusory communications data. For example, as shown in FIG. 1, the carrier/service provider server 100 may receive a request from first user 101A to substitute communications data (e.g. voice call data, e-mail data, text message data, VoIP data) provided to the to the carrier/service provider server 100 by a known first user 101A with illusory communications data.

Then, the operation 504 illustrates transmitting the one or more illusory communications data to a second user. For example, as shown in FIG. 1, the communications data transceiver module 102 of the carrier/service provider server 100 may transmit data 110B to second user 101B in which original communications data provided to the carrier/service provider server 100 by the first user 101A may be substituted with illusory ID data 105-2A associated with first user 101A.

Further, the operation 506 illustrates receiving one or more requests to substitute one or more audible phrases associated with the first user having a known identity with one or more illusory audible phrases. For example, as shown in FIG. 1, the carrier/service provider server 100 may receive a request from first user 101A to substitute audio communications data including data representing an audible phrase transmitted to the to the carrier/service provider server 100 by the first user 101A with illusory communications data. Illusory communications data may include a replacement audible phrase (e.g. “I can't talk right now” may be substituted with “That person is sitting right next to me.”) The call modification logic 103-3 may analyze incoming communications data from the first user 101A and cause the communications data transceiver module 102 to transmit a corresponding substitute illusory communications data to second user 101B.

Further, the operation 508 illustrates receiving one or more requests to substitute one or more audible tones associated with the first user having a known identity with one or more illusory audible tones. For example, as shown in FIG. 1, the carrier/service provider server 100 may receive a request from first user 101A to substitute audio communications data including data representing an audible tone transmitted to the carrier/service provider server 100 by the first user 101A with illusory communications data. Illusory communications data may include a replacement tone (e.g. background noise from a concert crowd may be substituted with tones indicative of an automobile engine). The call modification logic 103-3 may analyze incoming communications data from the first user 101A and cause the communications data transceiver module 102 to transmit corresponding substitute illusory communications data to second user 101B.

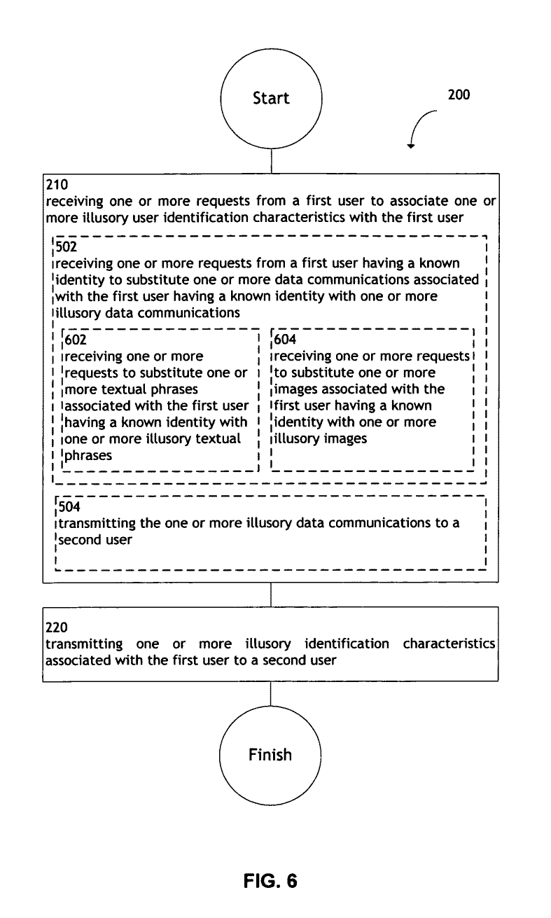

FIG. 6 illustrates alternative embodiments of the example operational flow 200 of FIG. 2. FIG. 6 illustrates example embodiments where the operation 210 may include at least one additional operation. Additional operations may include an operation 602, and/or an operation 604. Further, the operation 602 illustrates receiving one or more requests to substitute one or more textual phrases associated with the first user having a known identity with one or more illusory textual phrases. For example, as shown in FIG. 1, the carrier/service provider server 100 may receive a request from first user 101A to substitute communications data including data representing text transmitted to the carrier/service provider server 100 by the first user 101A with illusory communications data. Illusory communications data may include replacement text (e.g. “We have a date at 6:00 pm” may be substituted with “The meeting is scheduled for 6:00 pm”). The call modification logic 103-3 may analyze incoming communications data from the first user 101A and cause the communications data transceiver module 102 to transmit corresponding substitute illusory communications data to second user 101B.

Further, the operation 604 illustrates receiving one or more requests to substitute one or more images associated with the first user having a known identity with one or more illusory images. For example, as shown in FIG. 1, the carrier/service provider server 100 may receive a request from first user 101A to substitute communications data including graphical communications data provided to the to the carrier/service provider server 100 by the first user 101A with illusory communications data. Illusory communications data may include a replacement image (e.g. a male icon may be substituted with a female icon; one user photo may be substituted for another user photo). The call modification logic 103-3 may analyze incoming communications data from the first user 101A and cause the communications data transceiver module 102 to transmit corresponding substitute illusory communications data to second user 101B.

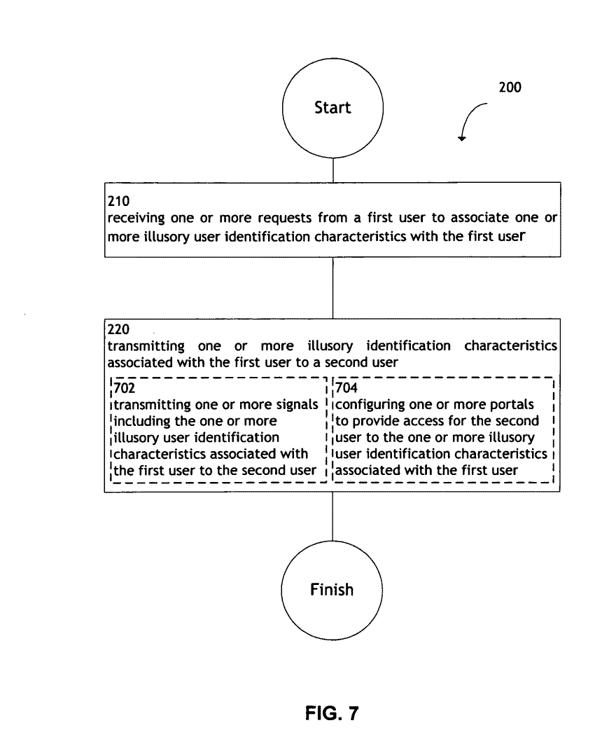

FIG. 7 illustrates alternative embodiments of the example operational flow 200 of FIG. 2. FIG. 7 illustrates example embodiments where the operation 220 may include at least one additional operation. Additional operations may include an operation 702 and/or an operation 704.

The operation 702 illustrates transmitting one or more signals including the one or more illusory user identification characteristics associated with the first user to the second user. For example, as shown in FIG. 1, the communications data transceiver module 102 of the carrier/service provider server 100 may transmit signals (e.g. electrical signals, radio frequency signals) 110B including illusory ID data 105-2 associated with first user 101A to a user communications device 106B associated with second user 101B. The signals including the illusory ID data 105-2A may be received by a communications modules 106-2B of the user communications device 106B and presented to the second user 101B via the user interface 106-3B of the user communications device 106B. The communications data transceiver module 102 may transmit signals 110B for any number of communications purposes including, but not limited to a voice calls (e.g. a landline or wireless phone call), a text messages, an e-mails or a VoIP calls.

The operation 704 illustrates configuring one or more portals to provide access for the second user to the one or more illusory user identification characteristics associated with the first user. For example, as shown in FIG. 1, the carrier/service provider server 100 may provide an access portal (e.g. controlled access of a web portal associated with the memory 104 of carrier/service provider server 100) which may allow second user 101B to access user A data 105A maintained by the carrier/service provider server 100. The second user 101B may access the portal via the user communications device 106B whereby the second user 101B may provide a user input to navigate the portal to data maintained by the carrier/service provider server 100.

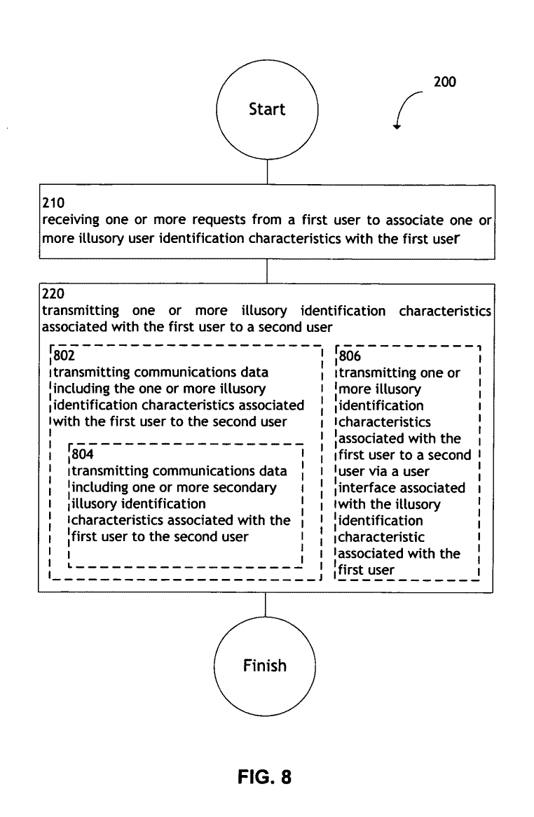

FIG. 8 illustrates alternative embodiments of the example operational flow 200 of FIG. 2. FIG. 8 illustrates example embodiments where the operation 220 may include at least one additional operation. Additional operations may include an operation 802, an operation 804, and/or an operation 806.

The operation 802 illustrates transmitting communications data including the one or more illusory identification characteristics associated with the first user to the second user. For example, as shown in FIG. 1, the communications data transceiver module 102 of the carrier/service provider server 100 may transmit communications data 110B (e.g. data formatted according to a communications protocol such as TCP/IP, SMTP, Session Initiation Protocol for VoIP, and the like) including illusory ID data 105-2A associated with first user 101A to a user communications device 106B associated with second user 101B. The illusory ID data 105-2A may be received by a communications modules 106-2B of the user communications device 106B and presented to the second user 101B via the user interface 106-3B of the user communications device 106B.

Further, the operation 804 illustrates transmitting communications data including one or more secondary illusory identification characteristics associated with the first user to the second user. For example, as shown in FIG. 1, the communications data transceiver module 102 of the carrier/service provider server 100 may transmit communications data 110B including a secondary illusory identification characteristic (e.g. illusory ID data 105-2A′, illusory ID data 105-2A″, etc.) associated with first user 101A to a user communications device 106B associated with second user 101B. The secondary illusory identification characteristic may be transmitted to the second user 101B in response to an illusory authentication by the second user 101B (e.g. a user authentication is requested of the second user 101B but non-illusory ID data 105-1A data is not provided) so that the second user 101B may be lead to believe that he or she is viewing non-illusory data when, in fact, secondary illusory ID data 105-2A′ is transmitted to the second user 101B.

The operation 806 illustrates transmitting one or more illusory identification characteristics associated with the first user to a second user via a user interface associated with the illusory identification characteristic associated with the first user. For example, as shown in FIG. 1, the communications data transceiver module 102 of the carrier/service provider server 100 may transmit data 110B including illusory ID data 105-2A associated with first user 101A to a user communications device 106B associated with second user 101B. The data 110B may further include user interface instructions which may cause user communications device 106B to present a particular user interface 106-3B to second user 101B according to the illusory ID data 105-2A. The user interface 106-3B may include various displayed images and/or tones, user input options, and the like, which are associated with illusory ID data 105-2A. For example, when illusory ID data 105-2A is transmitted to second user 101B, a password prompt may be provided to the second user 101B. Alternately, when illusory ID data 105-2A′ is transmitted to second user 101B, no prompt may be provided to the second user 101B.

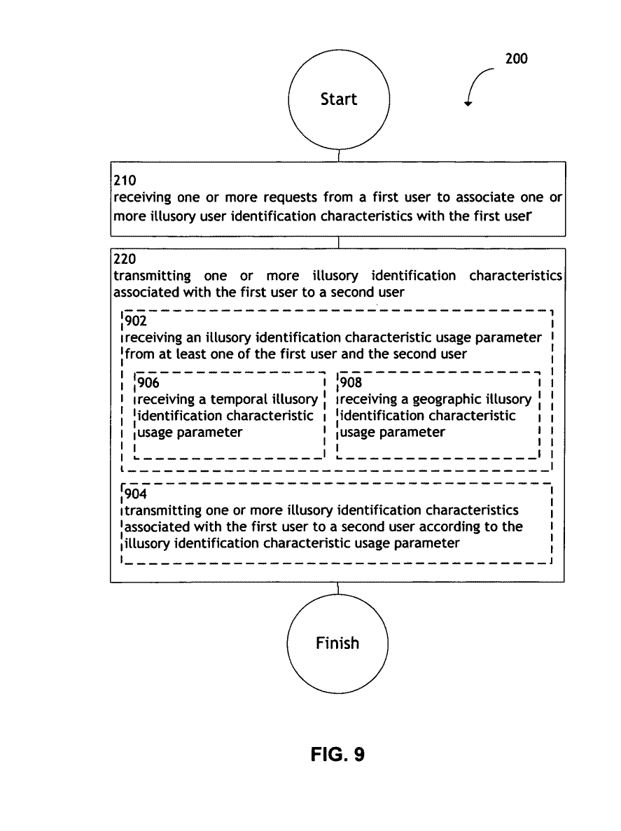

FIG. 9 illustrates alternative embodiments of the example operational flow 200 of FIG. 2. FIG. 9 illustrates example embodiments where the operation 220 may include at least one additional operation. Additional operations may include an operation 902, an operation 904, an operation 906, and/or an operation 908.

The operation 902 illustrates receiving an illusory identification characteristic usage parameter from at least one of the first user and the second user. For example, as shown in FIG. 1, the first user 101A or second user 101B may provide an input through a user interface 106-3 of user communications device 106A or user communications device 106B, respectively, whereby the first user 101A or second user 101B may define an illusory identification characteristic usage parameter which may be received by the communications data transceiver module 102 of the carrier/service provider server 100. An illusory identification characteristic usage parameter may provide a level of control over the transmission of illusory ID data 105-2A (e.g. which illusory ID data 105-2A should be transmitted, times at which certain illusory ID data 105-2A may be transmitted, locations to which illusory ID data 105-2A may be transmitted, etc.) by the first user 101A or second user 101B.

Then, the operation 904 illustrates transmitting one or more illusory identification characteristics associated with the first user to a second user according to the illusory identification characteristic usage parameter. For example, as shown in FIG. 1, the communications data transceiver module 102 of the carrier/service provider server 100 may transmit data 110B including illusory ID data 105-2A associated with first user 101A to a user communications device 106B associated with second user 101B according to an illusory identification characteristic usage parameter. An illusory identification characteristic usage parameter may control the manner in which the illusory ID data 105-2A is provided to second user 101B (e.g. the illusory ID data 105-2A may only be transmitted to second user 101B at certain times of the day while non-illusory ID data 105-1A may be transmitted to second user 101B at other times of the day).

Further, the operation 906 illustrates receiving a temporal illusory identification characteristic usage parameter. For example, as shown in FIG. 1, the first user 101A or second user 101B may provide an input through a user interface 106-3 of user communications device 106A or user communications device 106B, respectively, whereby the first user 101A or second user 101B may define a temporal illusory identification characteristic usage parameter which may be received by the communications data transceiver module 102 of the carrier/service provider server 100. The temporal illusory identification characteristic usage parameter may dictate various times of day at which the non-illusory ID data 105-1A and/or illusory ID data 105-2A may be transmitted to second user 101B.

Further, the operation 908 illustrates receiving a geographic illusory identification characteristic usage parameter. For example, as shown in FIG. 1, the first user 101A or second user 101B may provide an input through a user interface 106-3 of user communications device 106A or user communications device 106B, respectively, whereby the first user 101A or second user 101B may define a geographic illusory identification characteristic usage parameter which may be received by the communications data transceiver module 102 of the carrier/service provider server 100. The geographic illusory identification characteristic usage parameter may dictate various geographic locations of one or more of the first user 101A or second user 101B (e.g. as determined by a GPS sensor module 106-1B) at which the non-illusory ID data 105-1A and/or illusory ID data 105-2A may be transmitted to second user 101B.

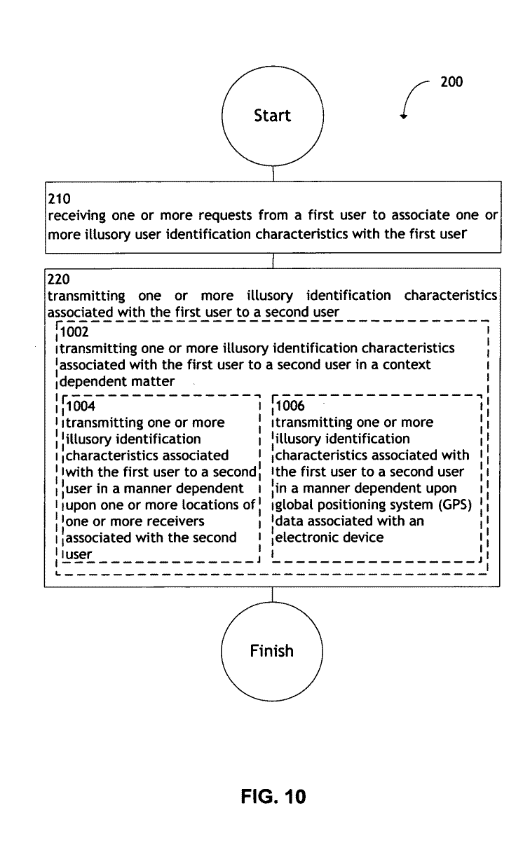

FIG. 10 illustrates alternative embodiments of the example operational flow 200 of FIG. 2. FIG. 10 illustrates example embodiments where the operation 220 may include at least one additional operation. Additional operations may include an operation 1002, an operation 1004, and/or an operation 1006.

The operation 1002 illustrates transmitting one or more illusory identification characteristics associated with the first user to a second user in a context dependent manner. For example, as shown in FIG. 1, the communications data transceiver module 102 of the carrier/service provider server 100 may transmit data 110B including illusory ID data 105-2A associated with first user 101A to a user communications device 106B associated with second user 101B according to a context (e.g. a location of second user 101B, a proximity of a third party to second user 101B, and the like) of at least one of the first user 101A and the second user 101B.

Further, the operation 1004 illustrates transmitting one or more illusory identification characteristics associated with the first user to a second user in a manner dependent upon one or more locations of one or more transceivers associated with the second user. For example, as shown in FIG. 1, the communications modules 106-2B of the user communications device 106B associated with the second user 101B may include one or more transceivers (e.g. RF receivers, optical transceivers, modem transceivers, and the like) for transceiving data 110B from the carrier/service provider server 100. The carrier/service provider server 100 may detect the location of the user communications device 106B through communication with the transceiver of the user communications device 106B. The carrier/service provider server 100 may detect the location by monitoring a geographic indicator (e.g. a cell tower location, e-mail service provider, telephone area code, and the like) associated with the transceiver of the user communications device 106B. The user-ID management logic 103-1 may cause the communications data transceiver module 102 of the carrier/service provider server 100 to transmit non-illusory ID data 105-1A and/or illusory ID data 105-2A according to the location of the one or more transceivers (e.g. illusory ID data 105-2A may be transmitted to second user 101B when the second user 101B is in a public location while non-illusory ID data 105-1A may be transmitted when the second user 101B is in a home or office).

Further, the operation 1006 illustrates transmitting one or more illusory identification characteristics associated with the first user to a second user in a manner dependant upon global positioning system (GPS) data associated with an electronic device. For example, as shown in FIG. 1, the user communications device 106B associated with second user 101B may include a GPS sensor module 106-1B including one or more receivers for receiving signals from a GPS satellite 107. The GPS data 110B associated with the location of the user communications device 106B may be received by the communications data transceiver module 102 of the carrier/service provider server 100. The user-ID management logic 103-1 may cause the communications data transceiver module 102 of the carrier/service provider server 100 to transmit non-illusory ID data 105-1A and/or illusory ID data 105-2A according to the GPS data 110B (e.g. illusory ID data 105-2A may be transmitted to second user 101B when GPS data 110B indicates that second user 101B is in a public location while non-illusory ID data 105-1A may be transmitted when GPS data 110B indicates that second user 101B is in a home or office).

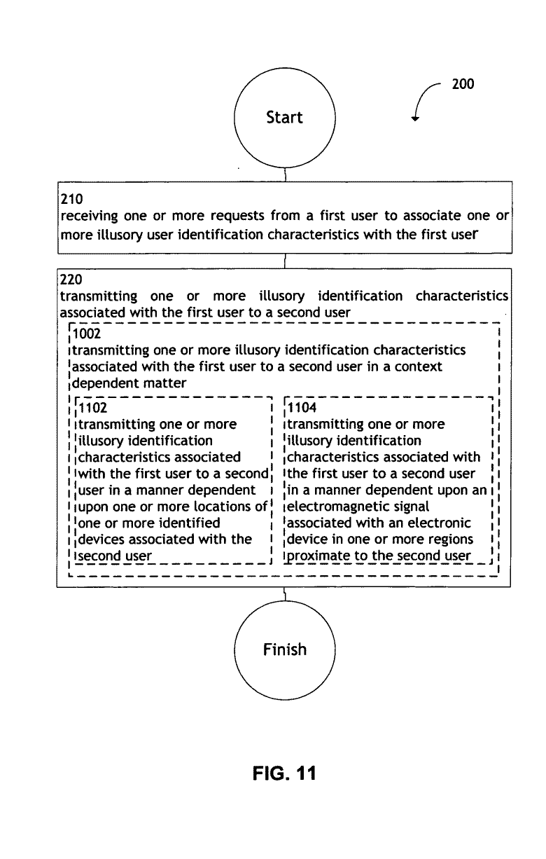

FIG. 11 illustrates alternative embodiments of the example operational flow 200 of FIG. 2. FIG. 11 illustrates example embodiments where the operation 220 may include at least one additional operation. Additional operations may include an operation 1102, and/or an operation 1104.

Operation 1102 illustrates transmitting one or more illusory identification characteristics associated with the first user to a second user in a manner dependent upon one or more locations of one or more identified devices associated with the second user. For example, as shown in FIG. 1, the carrier/service provider server 100 may detect the location of the user communications device 106B associated with second user 101B (e.g. a cell phone, satellite phone, Blackberry®, landline phone, a VoIP enabled device and/or computing device) associated with second user 101B through communication with the user communications device 106B. The carrier/service provider server 100 may detect the location by monitoring a geographic indicator (e.g. a cell tower location, e-mail service provider, telephone area code, and the like) associated with the user communications device 106B. The user-ID management logic 103-1 may cause the communications data transceiver module 102 of the carrier/service provider server 100 to transmit non-illusory ID data 105-1A and/or illusory ID data 105-2A according to the location of the user communications device 106B (e.g. illusory ID data 105-2A may be transmitted to second user 101B when the user communications device 106B is in a public location while non-illusory ID data 105-1A may be transmitted when the user communications device 106B is in a home or office).

Further, the operation 1104 illustrates transmitting one or more illusory identification characteristics associated with the first user to a second user in a manner dependant upon an electromagnetic signal associated with an electronic device in one or more regions proximate to the second user. For example, as shown in FIG. 1, the user communications device 106B associated with second user 101B may include a radio frequency sensor module 106-1 including one or more receivers for receiving RF signals (e.g. signals emitted by an electronic device 108 in a region proximate to second user 101B such as region 109). The data 110B associated with the RF environment proximate to the of the user communications device 106B may be received by the communications data transceiver module 102 of the carrier/service provider server 100. The user-ID management logic 103-1 may cause the communications data transceiver module 102 of the carrier/service provider server 100 to transmit non-illusory ID data 105-1A and/or illusory ID data 105-2A according to the RF data 110B (e.g. illusory ID data 105-2A may be transmitted to second user 101B when RF data 110B indicates that second user 101B is in proximity to an electronic device 108 while non-illusory ID data 105-1A may be transmitted when GPS data 110B indicates that second user 101B is not in proximity to electronic device 108).

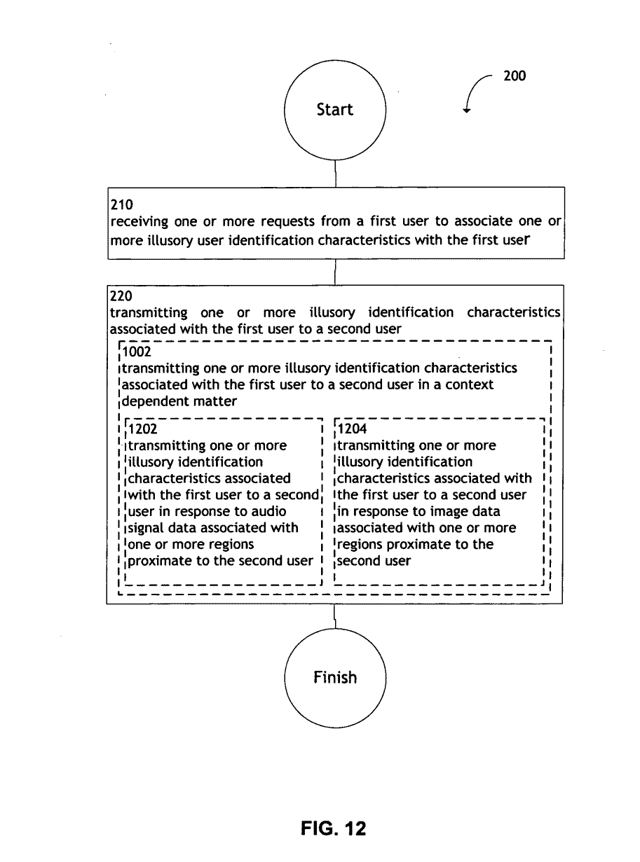

FIG. 12 illustrates alternative embodiments of the example operational flow 200 of FIG. 2. FIG. 12 illustrates example embodiments where the operation 220 may include at least one additional operation. Additional operations may include an operation 1202, and/or an operation 1204.

Further, the operation 1202 illustrates transmitting one or more illusory identification characteristics associated with the first user to a second user in response to audio signal data associated with one or more regions proximate to the second user. For example, as shown in FIG. 1, the user communications device 106B associated with second user 101B may include an audio sensor module 106-1 including one or more microphones for receiving audio signals (e.g. sounds emitted in a region proximate to second user 101B such as region 109). The data 110B associated with the audio environment proximate to the of the user communications device 106B may be received by the communications data transceiver module 102 of the carrier/service provider server 100. The user-ID management logic 103-1 employing audio recognition logic may cause the communications data transceiver module 102 of the carrier/service provider server 100 to transmit non-illusory ID data 105-1A and/or illusory ID data 105-2A according to the audio data 110B. The illusory ID data 105-2A may be transmitted to second user 101B when audio data 110B indicates that second user 101B may in proximity to a third party 101C (e.g. audio recognition logic detects sounds indicative of a home, an office, a person having an identified voice print, and the like) while non-illusory ID data 105-1A may be transmitted when audio data 110B indicates that second user 101B is not in proximity to third party 101C.

Further, the operation 1204 illustrates transmitting one or more illusory identification characteristics associated with the first user to a second user in response to image data associated with one or more regions proximate to the second user. For example, as shown in FIG. 1, the user communications device 106B associated with second user 101B may include an image sensor module 106-1 including one or more image capture devices for receiving images (e.g. images of a region proximate to second user 101B such as region 109). The image data 110B associated with the visual environment proximate to the of the user communications device 106B may be received by the communications data transceiver module 102 of the carrier/service provider server 100. The user-ID management logic 103-1 employing image recognition logic may cause the communications data transceiver module 102 of the carrier/service provider server 100 to transmit non-illusory ID data 105-1A and/or illusory ID data 105-2A according to the image data 110B. The illusory ID data 105-2A may be transmitted to second user 101B when image data 110B indicates that second user 101B may be in proximity to a third party 101C (e.g. image recognition logic detects an image of a home, office, identified person, and the like) while non-illusory ID data 105-1A may be transmitted when image data 110B indicates that second user 101B is not in proximity to third party 101C.

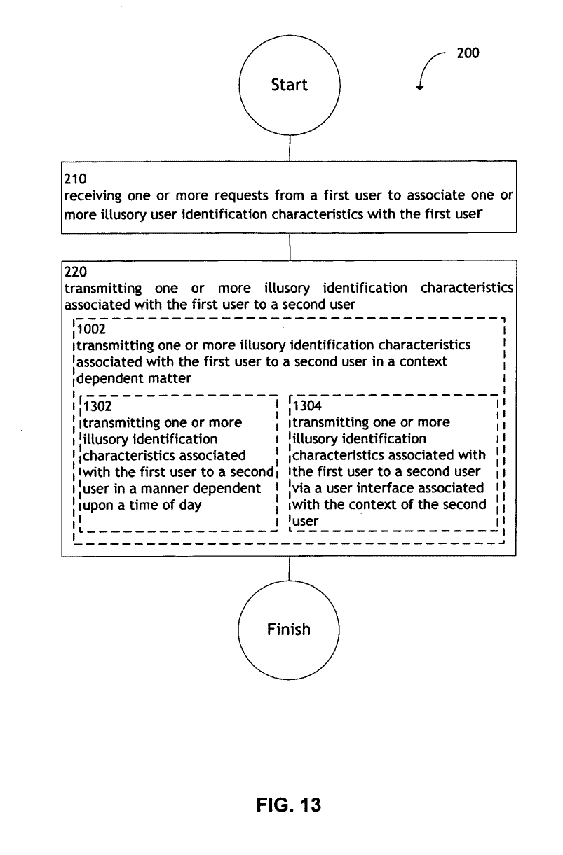

FIG. 13 illustrates alternative embodiments of the example operational flow 200 of FIG. 2. FIG. 13 illustrates example embodiments where the operation 220 may include at least one additional operation. Additional operations may include an operation 1302, and/or an operation 1304.

Further, the operation 1302 illustrates transmitting one or more illusory identification characteristics associated with the first user to a second user in a manner dependent upon a time of day. For example, as shown in FIG. 1, the user-ID management logic 103-1 may cause the communications data transceiver module 102 of the carrier/service provider server 100 to transmit non-illusory ID data 105-1A and/or illusory ID data 105-2A according to the image data 110B For example, illusory ID data 105-2A may be transmitted to second user 101B when timing data 110B indicates that second user 101B may be in proximity to a third party 101C (e.g. during a work day) while non-illusory ID data 105-1A may be transmitted when timing data 110B indicates that second user 101B may be not in proximity to third party 101C (e.g. outside of work hours).

Further, the operation 1304 illustrates transmitting one or more illusory identification characteristics associated with the first user to a second user via a user interface associated with the context of the second user. For example, as shown in FIG. 1, the communications data transceiver module 102 of the carrier/service provider server 100 may transmit data 110B including illusory ID data 105-2A associated with first user 101A to a user communications device 106B associated with second user 101B. The data 110B may further include user interface instructions which may cause user communications device 106B to present a particular user interface 106-3B to second user 101B according to the context (e.g. location, surroundings, time of day, state of user communications device 106B, and the like) of second user 101B. For example, the user interface instructions may cause user communications device 106B to present a user interface 106-3B including a user image associated with first user 101A when the context of second user 101B indicates that the second user 101B may be not be in proximity to a third party 101C (e.g. GPS data associated with user communications device 106B indicates that the second user 101B may be at home) while the user interface instructions may cause user communications device 106B to present a user interface 106-3B without a user image when the context of second user 101B indicates that the second user 101B may be in proximity to a third party 101C (e.g. GPS data associated with user communications device 106B indicates that the second user 101B may be at work).

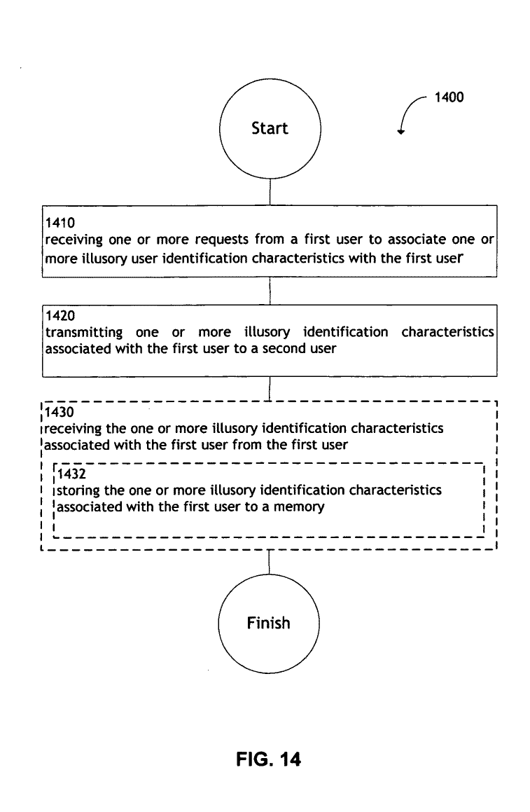

FIG. 14 illustrates an operational flow 1400 representing example operations related to specification of illusory identification characteristics. Operations 1410 and 1420 of operational flow 1400 may be similar to those of operations 210 and 220, respectively, as referenced above with respect operational flow 200. Additional operations may include an operation 1430, and/or an operation 1432.

After a start operation, operation 1410, and operation 1420, the operational flow 1400 moves to an operation 1430. Operation 1430 illustrates receiving the one or more illusory identification characteristics associated with the first user from the first user. For example, as shown in FIG. 1, the first user 101A may provide an input through a user interface 106-3A of user communications device 106A whereby the first user 101A may define an illusory identification characteristic to be associated with first user 101A which may be received by the communications data transceiver module 102 of the carrier/service provider server 100 (e.g. the first user 101A may specify an illusory user name, image, number to be associated with first user 101A).

The operation 1432 illustrates storing the one or more illusory identification characteristics associated with the first user to a memory. For example, as shown in FIG. 1, an illusory identification characteristic defined by first user 101A may be stored to user-ID database 105 as illusory ID data 105-2A associated with user A data 105A.

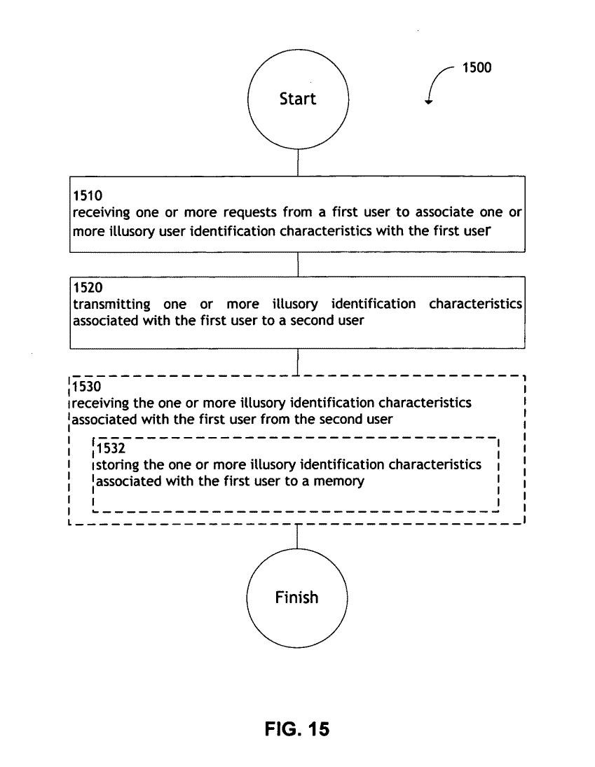

FIG. 15 illustrates an operational flow 1500 representing example operations related to specification of illusory identification characteristics. Operations 1510 and 1520 of operational flow 1500 may be similar to those of operations 210 and 220, respectively, as referenced above with respect operational flow 200. Additional operations may include an operation 1530, and/or an operation 1532.

After a start operation, operation 1510, and an operation 1520, the operational flow 1500 moves to an operation 1530. Operation 1530 illustrates receiving the one or more illusory identification characteristics associated with the first user from the second user. For example, as shown in FIG. 1, the second user 101B may provide an input through a user interface 106-3B of user communications device 106B whereby the second user 101B may define an illusory identification characteristic to be associated with first user 101A which may be received by the communications data transceiver module 102 of the carrier/service provider server 100 (e.g. the second user 101B may specify an illusory user name, image, number to be associated with first user 101A).

The operation 1532 illustrates storing the one or more illusory identification characteristics associated with the first user to a memory. For example, as shown in FIG. 1, an illusory identification characteristic defined by second user 101B may be stored to user-ID database 105 as illusory ID data 105-2A associated with user A data 105A.

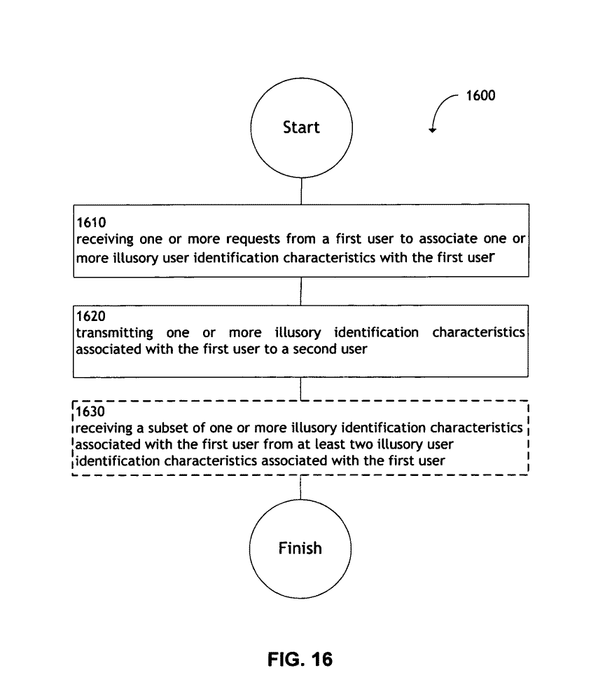

FIG. 16 illustrates an operational flow 1600 representing example operations related to selection of illusory identification characteristics second user 101B for transmission. Operations 1610 and 1620 of operational flow 1600 may be similar to those of operations 210 and 220, respectively, as referenced above with respect operational flow 200. Additional operations may include an operation 1630.

After a start operation, operation 1610, and an operation 1620, the operational flow 1600 moves to an operation 1630. Operation 1630 illustrates receiving a subset of one or more illusory identification characteristics associated with the first user from at least two illusory user identification characteristics associated with the first user. For example, as shown in FIG. 1, the first user 101A may provide an input through a user interface 106-3B of user communications device 106B whereby the first user 101A may select an illusory identification characteristic for transmission by the communications data transceiver module 102 of the carrier/service provider server 100 to second user 101B (e.g. the first user 101A may select one or more of illusory ID data 105-2A, illusory ID data 105-2A′, illusory ID data 105-2A″, etc. to be transmitted to second user 101B).

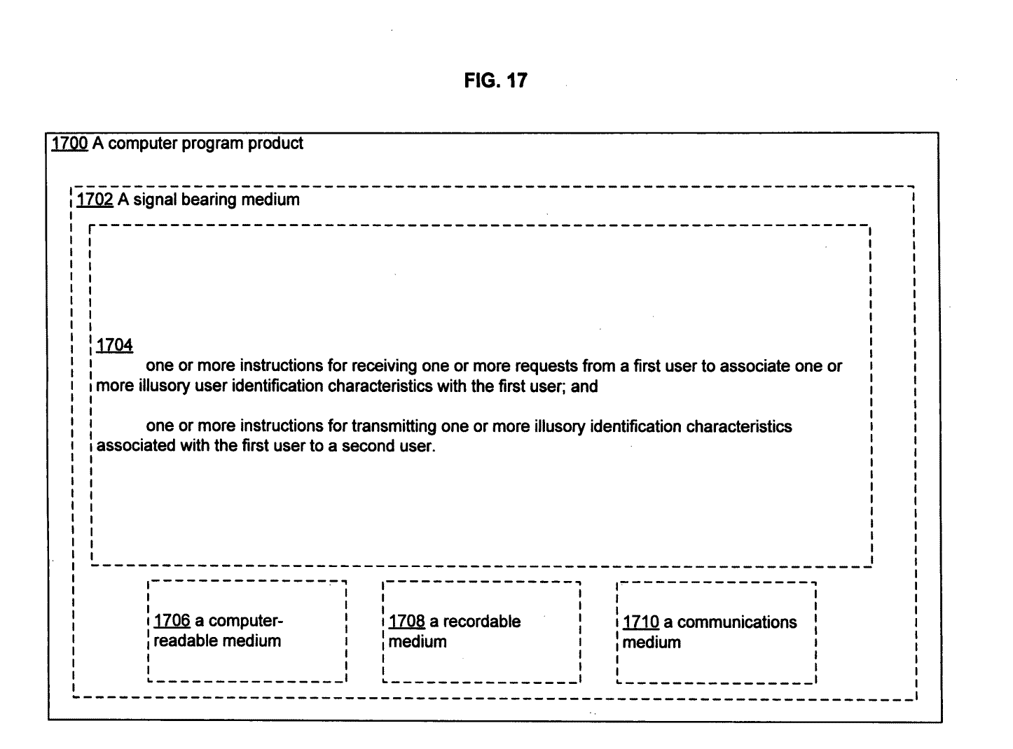

FIG. 17 illustrates a partial view of an example computer program product 1700 that includes a computer program 1704 for executing a computer process on a computing device. An embodiment of the example computer program product 1700 is provided using a signal-bearing medium 1702, and may include one or more instructions for receiving one or more requests from a first user to associate one or more illusory user identification characteristics with the first user; and one or more instructions for transmitting one or more illusory identification characteristics associated with the first user to a second user. The one or more instructions may be, for example, computer executable and/or logic-implemented instructions. In one implementation, the signal-bearing medium 1702 may include a computer-readable medium 1706. In one implementation, the signal bearing medium 1702 may include a recordable medium 1708. In one implementation, the signal bearing medium 1702 may include a communications medium 1710.

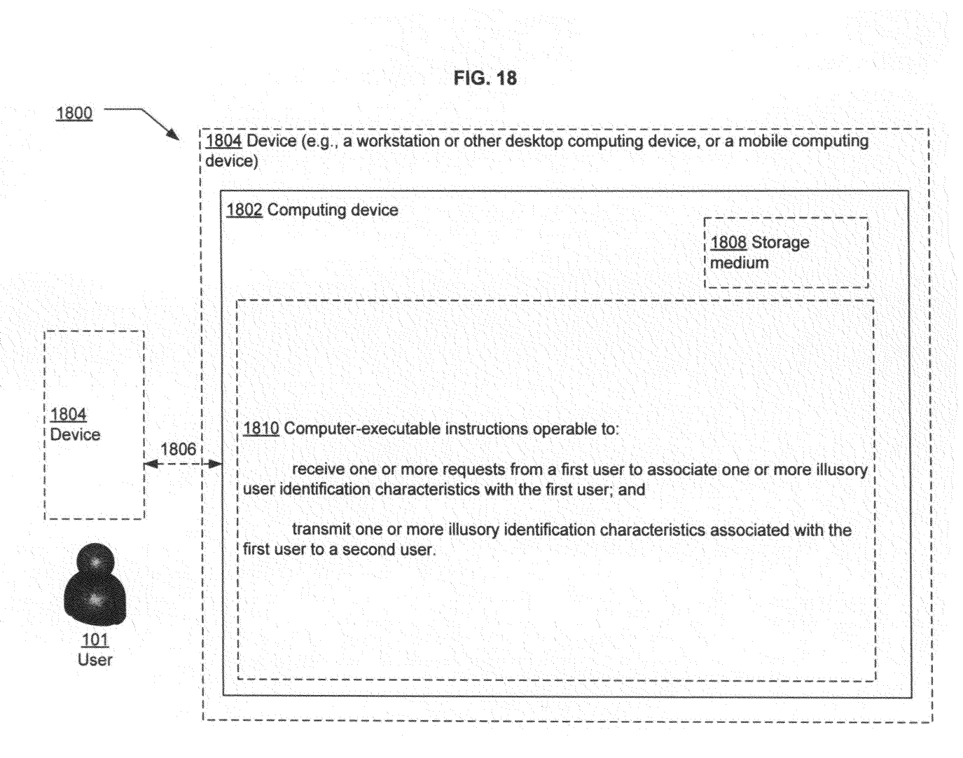

FIG. 18 illustrates an example system 1800 in which embodiments may be implemented. The system 1800 includes a computing system environment. The system 1800 also illustrates the user 101 using a device 1804, which is optionally shown as being in communication with a computing device 1802 by way of an optional coupling 1806. The optional coupling 1806 may represent a local, wide-area, or peer-to-peer network, or may represent a bus that is internal to a computing device (e.g., in example embodiments in which the computing device 1802 is contained in whole or in part within the device 1804). A storage medium 1808 may be any computer storage media.

The computing device 1802 includes computer-executable instructions 1810 that when executed on the computing device 1802 cause the computing device 1802 to receive one or more requests from a first user to associate one or more illusory user identification characteristics with the first user; and transmit one or more illusory identification characteristics associated with the first user to a second user. As referenced above and as shown in FIG. 18, in some examples, the computing device 1802 may optionally be contained in whole or in part within the device 1804.

In FIG. 18, then, the system 1800 includes at least one computing device (e.g., 1802 and/or 1804). The computer-executable instructions 1810 may be executed on one or more of the at least one computing device. For example, the computing device 1802 may implement the computer-executable instructions 1810 and output a result to (and/or receive data from) the computing device 1804. Since the computing device 1802 may be wholly or partially contained within the computing device 1804, the device 1804 also may be said to execute some or all of the computer-executable instructions 1810, in order to be caused to perform or implement, for example, various ones of the techniques described herein, or other techniques.

The device 1804 may include, for example, a portable computing device, workstation, or desktop computing device. In another example embodiment, the computing device 1802 is operable to communicate with the device 1804 associated with the user 101 to receive information about the input from the user 101 for performing data access and data processing and presenting an output of the user-health test function at least partly based on the user data.

Although a user 101 is shown/described herein as a single illustrated figure, those skilled in the art will appreciate that a user 101 may be representative of a human user, a robotic user (e.g., computational entity), and/or substantially any combination thereof (e.g., a user may be assisted by one or more robotic agents). In addition, a user 101, as set forth herein, although shown as a single entity may in fact be composed of two or more entities. Those skilled in the art will appreciate that, in general, the same may be said of “sender” and/or other entity-oriented terms as such terms are used herein.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.).

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include all possible multiple dependencies.

1. A method comprising:
receiving one or more requests from a first user to associate one or more illusory user identification characteristics with the first user; and
transmitting one or more illusory identification characteristics associated with the first user to a second user.

2-35. (canceled)

36. A system comprising:
means for receiving one or more requests from a first user to associate one or more illusory user identification characteristics with the first user; and
means for transmitting one or more illusory identification characteristics associated with the first user to a second user.

37. The system of claim 36, wherein the means for receiving one or more requests from a first user to associate one or more illusory user identification characteristics with the first user comprises:
means for receiving one or more requests from a first user having a known identity to associate one or more illusory identification characteristics with the first user.

38. The system of claim 36, wherein the means for receiving one or more requests from a first user to associate one or more illusory user identification characteristics with the first user comprises:
means for receiving one or more requests from a first user not having a known identity to associate one or more illusory identification characteristics with the first user.

39. The system of claim 36, wherein the means for receiving one or more requests from a first user to associate one or more illusory user identification characteristics with the first user comprises:
means for receiving one or more requests from the first user to associate an illusory user name with the first user.

40. The system of claim 36, wherein the means for receiving one or more requests from a first user to associate one or more illusory user identification characteristics with the first user comprises:
means for receiving one or more requests from the first user to associate an illusory user identification number with the first user.

41. The system of claim 36, wherein the means for receiving one or more requests from a first user to associate one or more illusory user identification characteristics with the first user comprises:
means for receiving one or more requests from the first user to associate an illusory telephone number with the first user.

42. The system of claim 36, wherein the means for receiving one or more requests from a first user to associate one or more illusory user identification characteristics with the first user comprises:
means for receiving one or more requests from the first user to associate an illusory area code with the first user.

43. The system of claim 36, wherein the means for receiving one or more requests from a first user to associate one or more illusory user identification characteristics with the first user comprises:
means for receiving one or more requests from the first user to associate an illusory voice signature with the first user.

44. The system of claim 36, wherein the means for receiving one or more requests from a first user to associate one or more illusory user identification characteristics with the first user further comprises:
means for receiving one or more requests from a first user having a known identity to substitute one or more communications data associated with the first user having a known identity with one or more illusory communications data; and
means for transmitting the one or more illusory communications data to a second user.

45. The system of claim 44, wherein the means for receiving one or more requests from a first user having a known identity to substitute one or more communications data associated with the first user having a known identity with one or more illusory communications data comprises:
means for receiving one or more requests to substitute one or more audible phrases associated with the first user having a known identity with one or more illusory audible phrases.

46. The system of claim 44, wherein the means for receiving one or more requests from a first user having a known identity to substitute one or more communications data associated with the first user having a known identity with one or more illusory communications data comprises:
means for receiving one or more requests to substitute one or more audible tones associated with the first user having a known identity with one or more illusory audible tones.

47. The system of claim 44, wherein the means for receiving one or more requests from a first user having a known identity to substitute one or more communications data associated with the first user having a known identity with one or more illusory communications data comprises:
means for receiving one or more requests to substitute one or more textual phrases associated with the first user having a known identity with one or more illusory textual phrases.

48. The system of claim 44, wherein the means for receiving one or more requests from a first user having a known identity to substitute one or more communications data associated with the first user having a known identity with one or more illusory communications data comprises:
means for receiving one or more requests to substitute one or more images associated with the first user having a known identity with one or more illusory images.

49. The system of claim 36, wherein the means for transmitting one or more illusory identification characteristics associated with the first user to a second user comprises:
means for transmitting one or more signals including the one or more illusory user identification characteristics associated with the first user to the second user.

50. The system of claim 36, wherein the means for transmitting one or more illusory identification characteristics associated with the first user to a second user comprises:
means for configuring one or more portals to provide access for the second user to the one or more illusory user identification characteristics associated with the first user.

51. The system of claim 36, wherein the means for transmitting one or more illusory identification characteristics associated with the first user to a second user further comprises:
means for transmitting communications data including the one or more illusory identification characteristics associated with the first user to the second user.

52. The system of claim 51, wherein the means for transmitting communications data including the one or more illusory identification characteristics associated with the first user to the second user further comprises:
means for transmitting communications data including one or more secondary illusory identification characteristics associated with the first user to the second user.

53. The system of claim 36, wherein the means for transmitting one or more illusory identification characteristics associated with the first user to a second user further comprises:
means for transmitting one or more illusory identification characteristics associated with the first user to a second user via a user interface associated with the illusory identification characteristic associated with the first user.

54. The system of claim 36, wherein the means for transmitting one or more illusory identification characteristics associated with the first user to a second user further comprises:
means for receiving an illusory identification characteristic usage parameter from at least one of the first user and the second user; and
means for transmitting one or more illusory identification characteristics associated with the first user to a second user according to the illusory identification characteristic usage parameter.

55. The system of claim 54, wherein the means for receiving an illusory identification characteristic usage parameter from at least one of the first user and the second user further comprises:
means for receiving a temporal illusory identification characteristic usage parameter.

56. The system of claim 54, wherein the means for receiving an illusory identification characteristic usage parameter from at least one of the first user and the second user further comprises:
means for receiving a geographic illusory identification characteristic usage parameter.

57. The system of claim 36, wherein the means for transmitting one or more illusory identification characteristics associated with the first user to a second user comprises:
means for transmitting one or more illusory identification characteristics associated with the first user to a second user in a context dependent manner.

58. The system of claim 57, wherein the means for transmitting one or more illusory identification characteristics associated with the first user to a second user in a context dependent manner comprises:
means for transmitting one or more illusory identification characteristics associated with the first user to a second user in a manner dependent upon one or more locations of one or more transceivers associated with the second user.

59. The system of claim 58, wherein the means for transmitting one or more illusory identification characteristics associated with the first user to a second user in a manner dependent upon one or more locations of one or more transceivers associated with the second user comprises:
means for transmitting one or more illusory identification characteristics associated with the first user to a second user in a manner dependant upon global positioning system (GPS) data associated with an electronic device.

60. The system of claim 57, wherein the means for transmitting one or more illusory identification characteristics associated with the first user to a second user in a context dependent manner comprises:
means for transmitting one or more illusory identification characteristics associated with the first user to a second user in a manner dependent upon one or more locations of one or more identified devices associated with the second user.

61. The system of claim 57, wherein the means for transmitting one or more illusory identification characteristics associated with the first user to a second user in a context dependent manner comprises:
means for transmitting one or more illusory identification characteristics associated with the first user to a second user in a manner dependant upon an electromagnetic signal associated with an electronic device in one or more regions proximate to the second user.

62. The system of claim 57, wherein the means for transmitting one or more illusory identification characteristics associated with the first user to a second user in a context dependent manner comprises:
means for transmitting one or more illusory identification characteristics associated with the first user to a second user in response to audio signal data associated with one or more regions proximate to the second user.

63. The system of claim 57, wherein the means for transmitting one or more illusory identification characteristics associated with the first user to a second user in a context dependent manner comprises:
means for transmitting one or more illusory identification characteristics associated with the first user to a second user in response to image data associated with one or more regions proximate to the second user.

64. The system of claim 57, wherein the means for transmitting one or more illusory identification characteristics associated with the first user to a second user in a context dependent manner comprises:
means for transmitting one or more illusory identification characteristics associated with the first user to a second user in a manner dependent upon a time of day.

65. The system of claim 57, wherein the means for transmitting one or more illusory identification characteristics associated with the first user to a second user in a context dependent manner comprises:
means for transmitting one or more illusory identification characteristics associated with the first user to a second user via a user interface associated with the context of the second user.

66. The system of claim 36, further comprising:
means for receiving the one or more illusory identification characteristics associated with the first user from the first user.

67. The system of claim 66, wherein the means for receiving the one or more illusory identification characteristics associated with the first user from the first user further comprises:
means for storing the one or more illusory identification characteristics associated with the first user to a memory.

68. The system of claim 36, further comprising:
means for receiving the one or more illusory identification characteristics associated with the first user from the second user.

69. The system of claim 68, wherein the means for receiving the one or more illusory identification characteristics associated with the first user from the second user further comprises:
means for storing the one or more illusory identification characteristics associated with the first user to a memory.

70. The system of claim 36, further comprising:
means for receiving a subset of one or more illusory identification characteristics associated with the first user from at least two illusory user identification characteristics associated with the first user.

71. A system comprising:
circuitry for receiving one or more requests from a first user to associate one or more illusory user identification characteristics with the first user; and
circuitry for transmitting one or more illusory identification characteristics associated with the first user to a second user.

72. A computer program product comprising:
a signal-bearing medium bearing:
one or more instructions receiving one or more requests from a first user to associate one or more illusory user identification characteristics with the first user; and
one or more instructions transmitting one or more illusory identification characteristics associated with the first user to a second user.

73. The computer program product of claim 72, wherein the signal-bearing medium includes a computer-readable medium.

74. The computer program product of claim 72, wherein the signal-bearing medium includes a recordable medium.

75. The computer program product of claim 72, wherein the signal-bearing medium includes a communications medium.

76. A system comprising:
a computing device; and
instructions that when executed on the computing device cause the computing device to:
receive one or more requests from a first user to associate one or more illusory user identification characteristics with the first user; and
transmit one or more illusory identification characteristics associated with the first user to a second user.

77. The system of claim 76, wherein the computing device comprises:
one or more of a personal digital assistant (PDA), a personal entertainment device, a mobile phone, a laptop computer, a tablet personal computer, a networked computer, a computing system comprised of a cluster of processors, a computing system comprised of a cluster of servers, a workstation computer, and/or a desktop computer.

78. The system of claim 76, wherein the computing device is operable to receive one or more requests from a first user to associate one or more illusory user identification characteristics with the first user and transmit one or more illusory identification characteristics associated with the first user to a second user from at least one memory.
